(19) United States
(12) Patent Application Publication
(10) Pub. No.: US 2026/0106320 A1
(43) Pub. Date: Apr. 16, 2026

(54) CERAMIC COMPOSITE SEPARATOR AND METHOD FOR MANUFACTURING THE SAME

(71) Applicant: Electrovaya Inc., Mississauga (CA)

(72) Inventors: Trevor Grant, Ontario (CA); Rajshekar DasGupta, Oakville (CA); Sankar DasGupta, Mississauga (CA)

(21) Appl. No.: 19/115,723

(22) PCT Filed: Oct. 19, 2023
(86) PCT No.: PCT/IB2023/060590

§ 371 Date: Mar. 26, 2025

Related U.S. Application Data
(60) Provisional application No. 63/418,840, filed on Oct. 24, 2022.

(51) Int. Cl. H01M 50/446; H01M 10/052; H01M 50/403; H01M 50/426; H01M 50/434; H01M 50/443; H01M 50/449; H01M 50/489

(52) U.S. Cl. CPC H01M 50/446; H01M 10/052; H01M 50/403; H01M 50/426; H01M 50/434; H01M 50/443; H01M 50/449; H01M 50/489

(57) ABSTRACT

A ceramic composite separator and a method of preparing the ceramic composite separator are provided. The ceramic composite separator includes a polymeric scaffold and a coating including a plurality of ceramic particles, wherein a portion of the plurality of ceramic particles is disposed in the polymeric scaffold. The method of preparing the ceramic composite separator includes providing a polymeric scaffold, forming a coating comprising a plurality of ceramic particles on the polymeric scaffold, and consolidating the coating on the polymeric scaffold to form the ceramic composite separator that includes the consolidated coating on the polymeric scaffold.

### CROSS-REFERENCE TO RELATED APPLICATION

This application claims priority and the benefit of U.S. Patent Application No. 63/418,840, filed Oct. 24, 2022, the contents of which are hereby incorporated by reference in their entirety.

### FIELD OF INVENTION

The disclosure relates to materials and designs for electrochemical energy storage devices and polymer/ceramic composite electrode separators for rechargeable lithium-based batteries. This disclosure is also related to methods for manufacturing lithium-conducting composite ceramic separators.

### BACKGROUND

Demand for lithium battery technologies with improved capacity, cycle life, and charging rate is ever-increasing along with commercial interest in passenger and commercial electric vehicles. Amongst all available technologies, solid-state lithium-based batteries have a potential to drastically increase energy density while enabling compatible advanced chemistries. However, one of the challenges to achieve commercial scale production for these advanced batteries is that certain advancements must be made to one or more core components, particularly with respect to the design, manufacturing, and more importantly, performance of such components. Among these core components, there is a need, in particular, for improved separators that can provide improved performance while simultaneously alleviating design and manufacturing concerns that plague current lithium-based battery technologies.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1A illustrates an example embodiment of a ceramic composite separator, in accordance with various embodiments.

FIG. 1B illustrates an example embodiment of a ceramic composite separator, in accordance with various embodiments.

FIG. 1C illustrates an example embodiment of a ceramic composite separator, in accordance with various embodiments.

FIG. 2A illustrates an example embodiment of an electrochemical cell, in accordance with various embodiments.

FIG. 2B illustrates an example embodiment of a bipolar electrochemical cell, in accordance with various embodiments.

FIG. 3 illustrates a method of preparing a ceramic composite separator, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

The technologies disclosed herein relate to ceramic composite separators (also referred to herein as lithium-conducting ceramic composite separators) and a method of preparing the same. As described herein, the disclosed ceramic composite separator can be used in lithium-based rechargeable batteries that can improve performance while alleviating the aforementioned short-comings of currently available separators. In accordance with various embodiments, the ceramic composite separator can include a polymeric scaffold and a coating of ceramic particles. In various embodiments, a portion of the ceramic particles of the coating may be disposed within the polymeric scaffold. In various embodiments, the disclosed ceramic composite separator can be prepared via the disclosed method. The method may include providing a polymeric scaffold, forming a coating that includes a plurality of ceramic particles on the polymeric scaffold, and consolidating the coating so as to form the ceramic composite separator that includes the consolidated coating on the polymeric scaffold.

Currently, composite coatings are often manufactured using a solution-based casting method, for example by casting a mixture or ceramic materials, binder, and solvent onto a temporary carrier substrate, after which the solvent may be removed to form a freestanding composite film. Although this casting method is suitable for small scale production of composite separators, it is not well suited for high throughput applications. In contrast, the technologies disclosed herein describe a method of forming a ceramic composite separator on a polymeric scaffold material. As disclosed, the use of a polymeric scaffold material enables coating and impregnation of ceramic particles at least partially or fully in the polymeric scaffold can be utilized to form a lithium-conducting solid composite separator, also referred to herein as a ceramic composite separator.

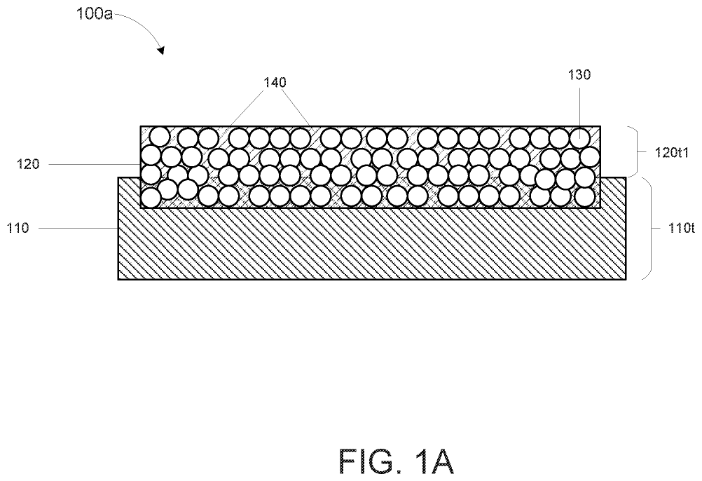

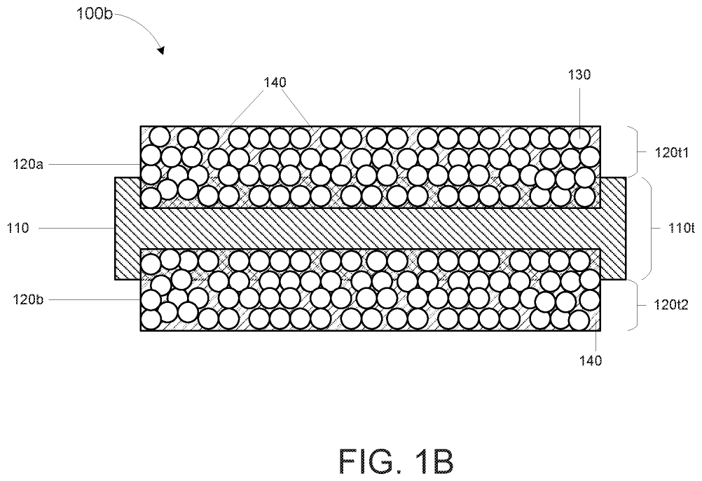

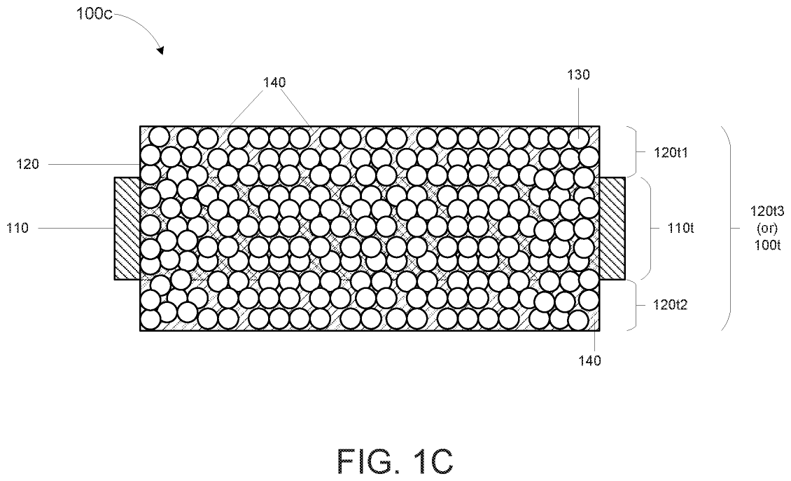

FIGS. 1A, 1B, and 1C illustrate embodiments of a ceramic composite separator, in accordance with various embodiments. FIG. 1A illustrates an example embodiment of a ceramic composite separator 100a, in accordance with various embodiments. As shown in FIG. 1A, the ceramic composite separator 100a includes a polymeric scaffold 110 and a coating 120 that includes ceramic particles 130. In some embodiments, a portion of the ceramic particles 130 can be disposed in a portion of the polymeric scaffold 110, as shown in FIG. 1A.

In various embodiments, the polymeric scaffold 110 can have a thickness 110t between about 5 microns and about 25 microns, between about 5 microns and 20 microns, between about 5 microns and about 15 microns, or about 5 microns and about 10 microns, inclusive of any thickness value ranges therebetween.

In various embodiments, the polymeric scaffold 110 can include at least one polymer selected from the group consisting of polyolefin, polyethylene terephthalate, polyacrylonitrile, polyester, polyamide, aromatic polyamide, polystyrene, polycarbonate, polytetrafluoroethylene, boron nitride, and cellulose-based materials.

In various embodiments, the polymeric scaffold 110 can have a pore size between about 5 microns and about 50 microns, between about 5 microns and about 40 microns, between about 5 microns and about 30 microns, between about 5 microns and about 25 microns, between about 5 microns and about 20 microns, between about 5 microns and about 15 microns, between about 5 microns and about 10 microns, inclusive of any pore size ranges therebetween.

In various embodiments, the polymeric scaffold 110 can have a porosity ranging between about 20% to about 80%, between about 25% to about 80%, between about 30% to about 80%, between about 35% to about 80%, between about 40% to about 80%, between about 45% to about 80%, between about 50% to about 80%, between about 55% to about 80%, between about 60% to about 80%, between about 20% to about 75%, between about 20% to about 70%, between about 20% to about 65%, between about 20% to about 60%, between about 20% to about 55%, between about 20% to about 50%, between about 20% to about 45%, between about 20% to about 40%, between about 20% to about 35%, between about 20% to about 30%, inclusive of any porosity ranges therebetween.

In various embodiments, the coating 120 (also referred to herein as consolidated coating 120) can have a thickness 120t between about 1 micron and about 20 microns, between about 1 micron and 15 microns, between about 1 micron and about 10 microns, between about 1 micron and about 5 microns, between about 1 micron and about 4 microns, between about 1 micron and about 3 microns, or between about 1 micron and about 3 microns, inclusive of any thickness value ranges therebetween.

In various embodiments, the ceramic particles 130 can include a material selected from the group of lithium perovskite (LLTO), lithium garnet (LLZO), lithium sulfide (LGPS, LPS), and NASICON-type (LAGP, LATP) ceramics.

In various embodiments, the ceramic particles 130 can have a particle size distribution ranging between about 0.01 micron and about 10 microns, between about 0.01 micron and about 5 microns, between about 0.01 micron and about 1 micron, between about 0.05 micron and about 10 microns, between about 0.05 micron and about 5 microns, between about 0.05 micron and about 1 micron, between about 0.1 micron and about 10 microns, between about 0.1 micron and about 5 microns, or between about 0.1 micron and about 1 micron, inclusive of any particle size distribution ranges therebetween.

In various embodiments, the ceramic particles 130 can have a mean particle size ranging between about 0.1 micron to about 5 microns, between about 0.1 micron to about 3 microns, between about 0.1 micron to about 2 microns, between about 0.1 micron to about 1 micron, between about 0.2 micron to about 5 microns, between about 0.2 micron to about 3 microns, between about 0.2 micron to about 2 microns, between about 0.2 micron to about 1 micron, between about 0.3 micron to about 5 microns, between about 0.3 micron to about 3 microns, between about 0.3 micron to about 2 microns, between about 0.3 micron to about 1 micron, between about 0.4 micron to about 5 microns, between about 0.4 micron to about 3 microns, between about 0.4 micron to about 2 microns, between about 0.4 micron to about 1 micron, between about 0.5 micron to about 5 microns, between about 0.5 micron to about 3 microns, between about 0.5 micron to about 2 microns, or between about 0.5 micron to about 1 micron, inclusive of any mean particle size ranges therebetween.

In various embodiments, an organic binder 140 can be used for holding the ceramic particles 130 in place within the coating 120. In various embodiments, the organic binder 140 can bind individual ceramic particles 130 to one another within the coating 120. In various embodiments, the organic binder 140 can bind individual ceramic particles 130 of the coating 120 with the polymeric scaffold 110.

In various embodiments, the organic binder 140 can include a fluorinated polymer. In various embodiments, the organic binder 140 can include polyvinylidene fluoride or polyvinylidene fluoride hexafluoropropylene. In various embodiments, the organic binder 140 can include a curable resin.

FIG. 1B illustrates an example embodiment of a ceramic composite separator 100b, in accordance with various embodiments. In various embodiments, the coating 120 can be a first coating 120a disposed on a first side of the polymeric scaffold 110 and another coating 120, which is designated as a second coating 120b, can be disposed on a second side of the polymeric scaffold 120, as illustrated in FIG. 1B. In other words, the coating 120 is formed on both sides (as coatings 120a and 120b) of the polymeric scaffold 110. In various embodiments, the second coating 120b can include a second plurality of ceramic particles 130 disposed on the second side of the polymeric scaffold 110. In some embodiments, a portion of the ceramic particles 130 can be disposed in the second portion of the polymeric scaffold 110, as shown in FIG. 1B.

In various embodiments, the coatings 120a and 120b (also referred to herein as consolidated coatings 120a and 120b) can have respective thicknesses 120t1 and 120t2 between about 1 micron and about 20 microns, between about 1 micron and 15 microns, between about 1 micron and about 10 microns, between about 1 micron and about 5 microns, between about 1 micron and about 4 microns, between about 1 micron and about 3 microns, or between about 1 micron and about 3 microns, inclusive of any thickness value ranges therebetween.

Other features of the ceramic composite separator 100b are similar or identical to those of the ceramic composite separator 100a as indicated by their reference numerals, and thus, will not be described in further detail.

FIG. 1C illustrates an example embodiment of a ceramic composite separator 100c, in accordance with various embodiments. As illustrated in FIG. 1C, the ceramic particles 130 of the coating 120 are entirely or substantially disposed within an entirety of the polymeric scaffold 110. In various embodiments, the ceramic composite separator 100c has a thickness 100t or 120t3 that is a combination of the thickness 110t of the polymeric scaffold 110 and the thicknesses 120t1 and 120t2 of the coating, as illustrated in FIG. 1C.

Other features of the ceramic composite separator 100c are similar or identical to those of the ceramic composite separators 100a and 100b as indicated by their respective reference numerals, and thus, will not be described in further detail.

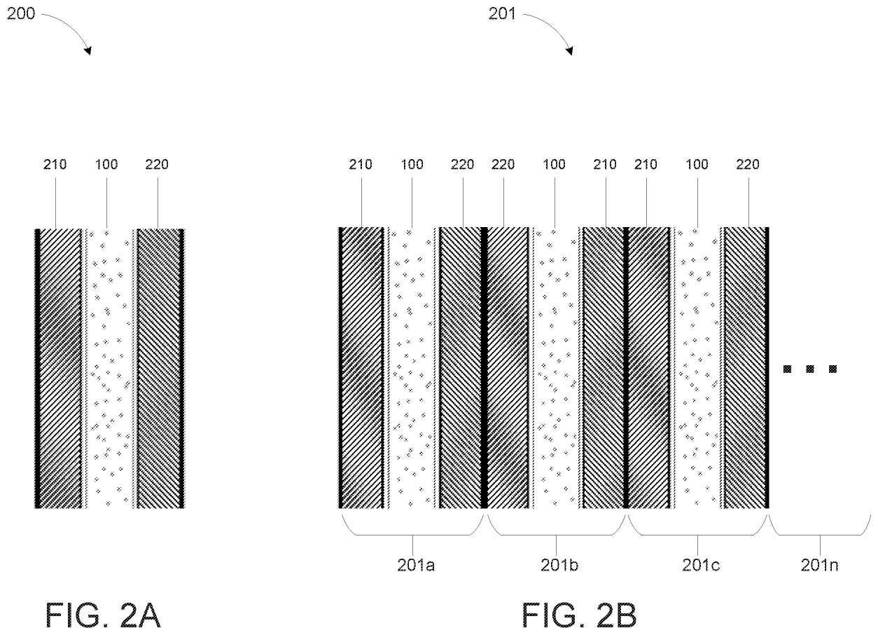

FIG. 2A illustrates an example embodiment of an electrochemical cell 200, in accordance with various embodiments. In accordance with various embodiments, the electrochemical cell 200 can include a battery, a lithium-based battery, a lithium battery, a lithium-ion battery, a solid-state lithium battery, a solid-state lithium-ion battery, a lithium polymer battery, or any other devices that utilize electrochemistry of chemical materials.

As illustrated in FIG. 2A, the electrochemical cell 200 can include a cathode 210, an anode 220, and the ceramic composite separator 100 (e.g., 100a, 100b, or 100c as described with respect to FIGS. 1A, 1B, and 1C) disposed therebetween.

FIG. 2B illustrates an example embodiment of a bipolar electrochemical cell 201, in accordance with various embodiments. As illustrated in FIG. 2B, the bipolar electrochemical cell 201 can be built by stacking two or more of the electrochemical cell 200 of FIG. 2A back to back to one another. In accordance with various embodiments, since the bipolar electrochemical cell 201 can be built by stacking two or more of the electrochemical cell 200 in a bipolar cell arrangement, each and every component of the bipolar electrochemical cell 201 can include respective components of the electrochemical cell 200, which are described respect to FIG. 2A, and thus, the various components of the bipolar electrochemical cell 201 are identical, similar or substantially similar to those of the electrochemical cell 200.

As illustrated in FIG. 2B, the bipolar electrochemical cell 201 can include a first cell 201a, a second cell 201b, a third cell 201b, and so on and so forth, to 201n. Each of the cells 201a . . . 201n, can include a cathode 210, an anode 220, and the ceramic composite separator 100 (e.g., 100a, 100b, or 100c as described with respect to FIGS. 1A, 1B, and 1C) disposed therebetween. In various embodiments, the bipolar electrochemical cell 201 can be constructed into a high voltage bipolar lithium-based battery having the components as disclosed herein with respect to FIGS. 1A, 1B, 1C, 2A, and 2B. In various embodiments, the voltage of this battery can be varied by changing the number of cells in the stack.

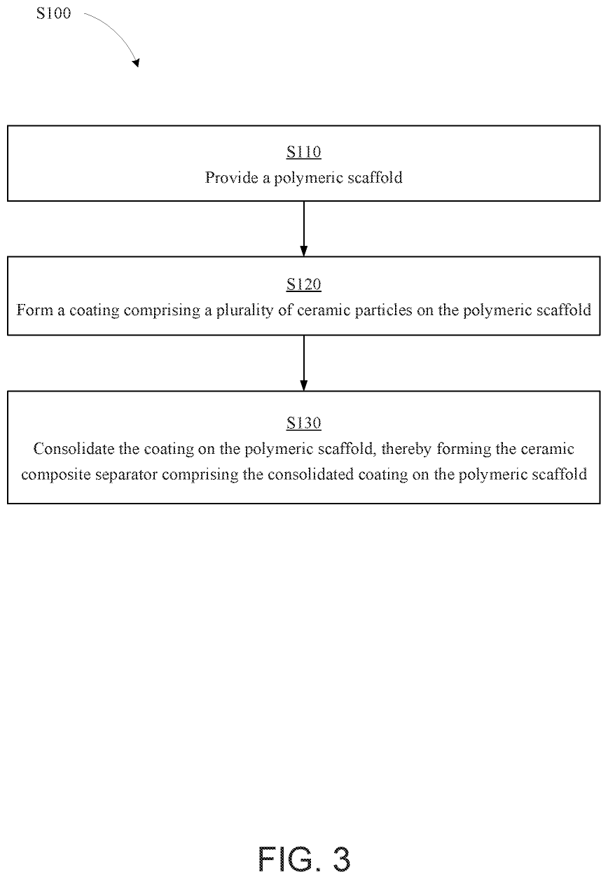

FIG. 3 illustrates a method S100 of preparing a ceramic composite separator, in accordance with various embodiments. In accordance with various embodiments, the method S100 can be used to prepare any of the ceramic composite separators 100a, 100b, or 100c, as described with respect to FIGS. 1A, 1B, and 1C.

As illustrated in FIG. 3, the method S100 includes, at step S110, providing a polymeric scaffold; at step S120, forming a coating comprising a plurality of ceramic particles on the polymeric scaffold; and at step S130, consolidating the coating on the polymeric scaffold, thereby forming the ceramic composite separator comprising the consolidated coating on the polymeric scaffold.

In accordance with various embodiments, the polymeric scaffold of FIG. 3 is similar or identical to the polymeric scaffold 110 as described with respect to FIGS. 1A, 1B, and 1C, and thus, will not be described in further detail. In accordance with various embodiments, the coating of FIG. 3 is similar or identical to the coatings 120, 120a, or 120b as described with respect to FIGS. 1A, 1B, and 1C, and thus, will not be described in further detail. In accordance with various embodiments, the ceramic particles of FIG. 3 is similar or identical to the ceramic particles 130 as described with respect to FIGS. 1A, 1B, and 1C, and thus, will not be described in further detail.

In various embodiments, forming the coating on the polymeric scaffold can occur by applying a suspension of ceramic particles in a solution to the polymeric scaffold, wherein the suspension of ceramic particles contains an organic binder dissolved in an organic solvent. In various embodiments, forming the coating on the polymeric scaffold can occur by impregnating a portion of the plurality of ceramic particles in the polymeric scaffold. In various embodiments, forming the coating on the polymeric scaffold can occur via an application of dip coating, blade coating, spray coating, rolling, or painting of the polymeric scaffold using the suspension of ceramic particles.

In various embodiments, the suspension of ceramic particles has about 10% to about 50%, about 15% to about 50%, about 20% to about 50%, about 25% to about 50%, about 30% to about 50%, about 35% to about 50%, about 40% to about 50%, about 10% to about 45%, about 10% to about 40%, about 10% to about 35%, about 10% to about 30%, about 10% to about 25%, or about 10% to about 20%, by mass of the ceramic particles.

In various embodiments, the suspension of ceramic particles has about 0.5% to about 25%, about 1% to about 25%, about 1.5% to about 25%, about 2% to about 25%, about 2.5% to about 25%, about 3% to about 25%, about 3.5% to about 25%, about 4% to about 25%, about 4.5% to about 25%, about 5% to about 25%, about 7% to about 25%, about 10% to about 25%, about 15% to about 25%, about 20% to about 25%, about 0.5% to about 20%, about 0.5% to about 15%, about 0.5% to about 10%, about 0.5% to about 8%, about 0.5% to about 7%, about 0.5% to about 6%, about 0.5% to about 5%, about 0.5% to about 4%, about 0.5% to about 3%, about 0.5% to about 2%, or about 0.5% to about 1%, by mass of the organic binder.

In various embodiments, the organic solvent includes at least one organic compound selected from the group consisting of acetone, ethanol, 1-propanol, 2-propanol, acetonitrile, diethyl ether, dimethylformamide, tetrahydrofuran, dimethyl sulfoxide, toluene, dimethyl carbonate, diethyl carbonate, ethyl methyl carbonate.

In various embodiments, consolidating the coating on the polymeric scaffold occurs via removal of the organic solvent under elevated temperature and/or application of a vacuum. In other words, consolidating the coating includes drying by heating or evaporation of solvent. In various embodiments, consolidating the coating on the polymeric scaffold occurs via curing of the organic binder by exposing to UV light, wherein the organic binder is photosensitive to the UV light. In various embodiments, calendaring can be performed after the coating is formed, for example, by pressing the coated polymeric scaffold.

In general, the following describes one method for producing a composite separator: a) create a suspension of a lithium-conducting ceramic material in a solution containing an organic solvent and an organic binder. b) coat the suspension onto a porous polymeric scaffold c) consolidate the film onto the polymeric scaffold

In various embodiments, the polymeric scaffold can include a material suitable for use as a battery separator for example, but not limited to, polyolefin, polyethylene terephthalate, polyacrylonitrile, polyester, polyamide, aromatic polyamide, polystyrene, polycarbonate, polytetrafluoroethylene, boron nitride, and cellulose-based materials. In some embodiments, the polymeric scaffold can have a thickness preferably below 25 microns, and preferably a thickness between about 10 microns and about 20 microns such that the thickness of the coated separator is below 25 microns. The polymer scaffold preferably has an average pore size greater than 5 microns and a porosity between 20 to 80% such that the ceramic particles may become impregnated within the scaffold material.

In various embodiments, the ceramic particles that includes a lithium-conducting ceramic material can be selected from the group of lithium perovskite (LLTO), lithium garnet (LLZO), lithium sulfide (LGPS, LPS), and NASICON-type (LAGP, LATP) ceramics. The ceramic may include about 10% to about 50% mass of the suspension. The ceramic particles preferably have a maximum particle size of 10 microns and a mean particle size of 0.1 to 5 microns, such that the ceramic particles may become impregnated within the scaffold material.

In various embodiments, the composite suspension may contain a dissociable lithium salt with a concentration between about 0.1 M and about 1 M to increase the lithium inventory of the resulting composite separator. The lithium salt be for example, but not limited to, LiPF₆, LiFSI, LiTFSI, or LiTDI.

In various embodiments, an organic solvent may be used to dissolve the binder material and disperse the ceramic material. The solvent should show high solubility towards the binder material such that it may be fully dissolved. The organic solvent may be for example, but not limited to acetone, ethanol, 1-propanol, 2-propanol, acetonitrile, diethyl ether, dimethylformamide, tetrahydrofuran, dimethyl sulfoxide, toluene, dimethyl carbonate, diethyl carbonate, ethyl methyl carbonate, or some combination thereof.

In various embodiments, the binder material is an organic polymer including, but not limited to polyvinylidene fluoride or polyvinylidene fluoride hexafluoropropylene. Films utilizing polymeric binders may be consolidated by removing the organic solvent under elevated temperature and/or application of vacuum pressure.

In various embodiments, the binder material includes monomers and/or oligomers having reactive alkene groups and a photoinitiator sensitive to ultraviolet light. Films using curable binders may be consolidated by exposure to ultraviolet light.

In various embodiments, the composite suspension is subject to dispersion by ultrasonic agitation. The composite suspension may be maintained under constant stirring to prevent agglomeration or settling of the ceramic particles.

In various embodiments, the composite suspension is deposited onto the polymeric scaffold by a coating technique, e.g, dip coating, blade coating, spray coating, rolling, or painting. The composite suspension may be deposited on one or both sides of the polymeric scaffold. The suspension is preferentially deposited onto both sides of the scaffold using dip coating.

In various embodiments, the composite separator may be placed between a lithium metal anode and lithiated metal cathode (for example, LiCoO₂, LiFePO₄, LiMn₂O₄, LiNiO₂, Li₂FePO₄F, Li(LiₐNiₓMn_{y}Co_{z}), or Li(LiₐNiₓAl_{y}Co_{z})), thereby forming a rechargeable solid-state lithium ion battery when combined with appropriate current collectors and packaging.

### RECITATION OF EMBODIMENTS

Embodiment 1. A ceramic composite separator, comprising: a polymeric scaffold; and a coating comprising a plurality of ceramic particles, wherein a portion of the plurality of ceramic particles is disposed in the polymeric scaffold.
Embodiment 2. The ceramic composite separator of Embodiment 1, wherein the coating is a first coating disposed on a first side of the polymeric scaffold and the plurality of ceramic particles is a first plurality of ceramic particles, further comprising: a second coating comprising a second plurality of ceramic particles disposed on a second side of the polymeric scaffold, wherein a portion of the second plurality of ceramic particles is disposed in the polymeric scaffold.
Embodiment 3. The ceramic composite separator of Embodiment 1, wherein the coating is formed on both sides of the polymeric scaffold.
Embodiment 4. The ceramic composite separator of any of Embodiments 1-3, further comprising: an organic binder, wherein the organic binder binds individual ceramic particles to one another within the coating, and wherein the organic binder binds individual ceramic particles of the coating with the polymeric scaffold.
Embodiment 5. The ceramic composite separator of Embodiment 4, wherein the organic binder comprises a fluorinated polymer.
Embodiment 6. The ceramic composite separator of Embodiment 5, wherein the organic binder is polyvinylidene fluoride or polyvinylidene fluoride hexafluoropropylene.
Embodiment 7. The ceramic composite separator of any of Embodiments 4-6, wherein the organic binder comprises a curable resin.
Embodiment 8. The ceramic composite separator of any of Embodiments 1-7, wherein the polymeric scaffold comprises at least one polymer selected from the group consisting of polyolefin, polyethylene terephthalate, polyacrylonitrile, polyester, polyamide, aromatic polyamide, polystyrene, polycarbonate, polytetrafluoroethylene, boron nitride, and cellulose-based materials.
Embodiment 9. The ceramic composite separator of any of Embodiments 1-8, wherein the polymeric scaffold has a thickness between about 5 microns and about 25 microns.
Embodiment 10. The ceramic composite separator of any of Embodiments 1-9, wherein the polymeric scaffold has a pore size between about 5 microns and about 50 microns.
Embodiment 11. The ceramic composite separator of any of Embodiments 1-10, wherein the polymeric scaffold has a porosity ranging between about 20% to about 80%.
Embodiment 12. The ceramic composite separator of any of Embodiments 1-11, wherein the plurality of ceramic particles comprises a material selected from the group of lithium perovskite (LLTO), lithium garnet (LLZO), lithium sulfide (LGPS, LPS), and NASICON-type (LAGP, LATP) ceramics.
Embodiment 13. The ceramic composite separator of any of Embodiments 1-12, wherein the plurality of ceramic particles has a particle size distribution ranging between about 0.01 micron and about 10 microns.
Embodiment 14. The ceramic composite separator of any of Embodiments 1-13, wherein the plurality of ceramic particles has a mean particle size ranging between about 0.1 micron to about 5 microns.
Embodiment 15. An electrochemical cell comprising a cathode, an anode, and the ceramic composite separator of any of Embodiments 1-14.
Embodiment 16. A bipolar electrochemical cell comprising the ceramic composite separator of any of Embodiment 1-14.
Embodiment 17. A method for preparing a ceramic composite separator, comprising: providing a polymeric scaffold; forming a coating comprising a plurality of ceramic particles on the polymeric scaffold; and consolidating the coating on the polymeric scaffold, thereby forming the ceramic composite separator comprising the consolidated coating on the polymeric scaffold.
Embodiment 18. The method of Embodiment 17, wherein forming the coating on the polymeric scaffold comprises applying a suspension of ceramic particles in a solution to the polymeric scaffold, wherein the suspension of ceramic particles contains an organic binder dissolved in an organic solvent.
Embodiment 19. The method of Embodiments 17 or 18, wherein forming the coating on the polymeric scaffold comprises impregnating a portion of the plurality of ceramic particles in the polymeric scaffold.
Embodiment 20. The method of Embodiments 18 or 19, wherein forming the coating on the polymeric scaffold occurs via an application of dip coating, blade coating, spray coating, rolling, or painting of the polymeric scaffold using the suspension of ceramic particles.
Embodiment 21. The method of any of Embodiments 17-20, wherein the coating is formed on both sides of the polymeric scaffold.
Embodiment 22. The method of any of Embodiments 18-21, wherein the suspension of ceramic particles has about 10% to about 50% by mass of the ceramic particles.
Embodiment 23. The method of any of Embodiments 18-22, wherein the suspension of ceramic particles has about 0.5% to about 25% by mass of the organic binder.
Embodiment 24. The method of any of Embodiments 18-23, wherein the organic solvent comprises at least one organic compound selected from the group consisting of acetone, ethanol, 1-propanol, 2-propanol, acetonitrile, diethyl ether, dimethylformamide, tetrahydrofuran, dimethyl sulfoxide, toluene, dimethyl carbonate, diethyl carbonate, ethyl methyl carbonate.
Embodiment 25. The method of any of Embodiments 18-24, wherein consolidating the coating on the polymeric scaffold occurs via removal of the organic solvent under elevated temperature and/or application of a vacuum.
Embodiment 26. The method of any of Embodiments 18-24, wherein consolidating the coating on the polymeric scaffold occurs via curing of the organic binder by exposing to UV light, wherein the organic binder is photosensitive to the UV light.
Embodiment 27. The method of any of Embodiments 17-26, wherein the consolidated coating has a thickness between about 1 micron and about 20 microns.
Embodiment 28. The method of any of Embodiments 18-27, wherein the organic binder comprises a fluorinated polymer.
Embodiment 29. The method of any of Embodiments 18-28, wherein the organic binder is polyvinylidene fluoride or polyvinylidene fluoride hexafluoropropylene.
Embodiment 30. The method of any of Embodiments 18-29, wherein the organic binder comprises a curable resin.
Embodiment 31. The method of any of Embodiments 17-30, wherein the polymeric scaffold comprises at least one polymer selected from the group consisting of polyolefin, polyethylene terephthalate, polyacrylonitrile, polyester, polyamide, aromatic polyamide, polystyrene, polycarbonate, polytetrafluoroethylene, boron nitride, and cellulose-based materials.
Embodiment 32. The method of any of Embodiments 17-31, wherein the polymeric scaffold has a thickness between about 5 microns and about 25 microns.
Embodiment 33. The method of any of Embodiments 17-32, wherein the polymeric scaffold has a pore size between about 5 microns and about 50 microns.
Embodiment 34. The method of any of Embodiments 17-33, wherein the polymeric scaffold has a porosity ranging between about 20% to about 80%.
Embodiment 35. The method of any of Embodiments 17-34, wherein the plurality of ceramic particles comprises a material selected from the group of lithium perovskite (LLTO), lithium garnet (LLZO), lithium sulfide (LGPS, LPS), and NASICON-type (LAGP, LATP) ceramics.
Embodiment 36. The method of any of Embodiments 17-35, wherein the plurality of ceramic particles has a particle size distribution ranging between about 0.01 micron and about 10 microns.
Embodiment 37. The method of any of Embodiments 17-36, wherein the plurality of ceramic particles has a mean particle size ranging between about 0.1 micron to about 5 microns.
Embodiment 38. An electrochemical cell comprising a cathode, an anode, and the ceramic composite separator produced via the method of any of Embodiment 17-37.
Embodiment 39. A bipolar electrochemical cell comprising the ceramic composite separator produced via any of Embodiment 17-37.

1. A ceramic composite separator, comprising:
a polymeric scaffold; and
a coating comprising a plurality of ceramic particles, wherein a portion of the plurality of ceramic particles is disposed in the polymeric scaffold.

2. The ceramic composite separator of claim 1, wherein the coating is a first coating disposed on a first side of the polymeric scaffold and the plurality of ceramic particles is a first plurality of ceramic particles, further comprising:
a second coating comprising a second plurality of ceramic particles disposed on a second side of the polymeric scaffold, wherein a portion of the second plurality of ceramic particles is disposed in the polymeric scaffold.

3. The ceramic composite separator of claim 1, wherein the coating is formed on both sides of the polymeric scaffold.

4. The ceramic composite separator of claim 1, further comprising:
an organic binder,
wherein the organic binder binds individual ceramic particles to one another within the coating, and
wherein the organic binder binds individual ceramic particles of the coating with the polymeric scaffold.

5. The ceramic composite separator of claim 4, wherein:
the organic binder comprises a fluorinated polymer;
the organic binder is polyvinylidene fluoride or polyvinylidene fluoride hexafluoropropylene; or
the organic binder comprises a curable resin.

6. (canceled)

7. (canceled)

8. The ceramic composite separator of claim 1, wherein the polymeric scaffold comprises at least one polymer selected from the group consisting of polyolefin, polyethylene terephthalate, polyacrylonitrile, polyester, polyamide, aromatic polyamide, polystyrene, polycarbonate, polytetrafluoroethylene, boron nitride, and cellulose-based materials.

9. The ceramic composite separator of claim 1, wherein the polymeric scaffold has:
a thickness between about 5 microns and about 25 microns;
a pore size between about 5 microns and about 50 microns; or
a porosity ranging between about 20% to about 80%.

10. (canceled)

11. (canceled)

12. The ceramic composite separator of claim 1, wherein the plurality of ceramic particles comprises a material selected from the group of lithium perovskite (LLTO), lithium garnet (LLZO), lithium sulfide (LGPS, LPS), and NASICON-type (LAGP, LATP) ceramics.

13. The ceramic composite material of claim 1, wherein the plurality of ceramic particles has;
a particle size distribution ranging between about 0.01 micron and about 10 microns; or
a mean particle size ranging between about 0.1 micron to about 5 microns.

14-16. (canceled)

17. A method for preparing a ceramic composite separator, comprising:
providing a polymeric scaffold;
forming a coating comprising a plurality of ceramic particles on the polymeric scaffold; and
consolidating the coating on the polymeric scaffold, thereby forming the ceramic composite separator comprising the consolidated coating on the polymeric scaffold.

18. The method of claim 17, wherein forming the coating on the polymeric scaffold comprises applying a suspension of ceramic particles in a solution to the polymeric scaffold, wherein the suspension of ceramic particles contains an organic binder dissolved in an organic solvent.

19. The method of claim 17, wherein forming the coating on the polymeric scaffold comprises impregnating a portion of the plurality of ceramic particles in the polymeric scaffold.

20. The method of claim 18, wherein forming the coating on the polymeric scaffold occurs via an application of dip coating, blade coating, spray coating, rolling, or painting of the polymeric scaffold using the suspension of ceramic particles.

21-24. (canceled)

25. The method of claim 18, wherein consolidating the coating on the polymeric scaffold occurs via removal of the organic solvent under elevated temperature and/or application of a vacuum or via curing of the organic binder by exposing to UV light, wherein the organic binder is photosensitive to the UV light.

26-39. (canceled)

40. An electrochemical cell comprising a cathode, an anode, a separator, wherein separator comprises:
a polymeric scaffold; and
a coating comprising a plurality of ceramic particles,
wherein a portion of the plurality of ceramic particles is disposed in the polymeric scaffold, and
wherein the plurality of ceramic particles has a particle size distribution ranging between about 0.01 micron and about 10 microns, or a mean particle size ranging between about 0.1 micron to about 5 microns.

41. The electrochemical cell of claim 40, wherein the coating is a first coating disposed on a first side of the polymeric scaffold and the plurality of ceramic particles is a first plurality of ceramic particles, further comprising:
a second coating comprising a second plurality of ceramic particles disposed on a second side of the polymeric scaffold, wherein a portion of the second plurality of ceramic particles is disposed in the polymeric scaffold.

42. The electrochemical cell of claim 40, wherein the coating is formed on both sides of the polymeric scaffold.

43. The electrochemical cell of claim 40, wherein the separator further comprises:
an organic binder,
wherein the organic binder binds individual ceramic particles to one another within the coating, and
wherein the organic binder binds individual ceramic particles of the coating with the polymeric scaffold.

44. The electrochemical cell of claim 43, wherein:
the organic binder comprises a fluorinated polymer;
the organic binder is polyvinylidene fluoride or polyvinylidene fluoride hexafluoropropylene; or
the organic binder comprises a curable resin.

45. The electrochemical cell of claim 40, wherein the polymeric scaffold has:
a thickness between about 5 microns and about 25 microns;
a pore size between about 5 microns and about 50 microns; or
a porosity ranging between about 20% to about 80%.
